(19) United States
(12) Patent Application Publication
(10) Pub. No.: US 2005/0068348 A1
(43) Pub. Date: Mar. 31, 2005

(54) Ink-jet recording apparatus

(75) Inventor: Toshihiko Ikeda, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/942,827

(22) Filed: Sep. 17, 2004

(30) Foreign Application Priority Data
Sep. 29, 2003 (JP) 2003-337002

(51) Int. Cl. B41J 29/38

(52) U.S. Cl. 347/5

(57) ABSTRACT

The ink-jet head can be accurately positioned facing a maintenance unit, even if the maintenance unit is not attached with a high installation accuracy. When “MAINTENANCE POSITION SETTING” is selected from the menu (S20: YES), a message which instructs positioning is displayed at the LCD 16b (S30). If then the OK button 16e is pushed (S40: YES), the user conducts positioning of the carriage 20 and maintenance unit 14 and it is decided that the carriage 20 has been moved to the adequate position, whereby the value stored in the carriage position register 110a, that is, the present position of the carriage 20, is stored in the EEPROM 125 as a maintenance position of the carriage 20 (S70).

### BACKGROUND OF THE INVENTION

1. Field of the Invention

The present invention relates to an ink-jet recording apparatus.

2. Description of the Related Art

Commonly, in ink-jet recording apparatuses of a serial type, printing is carried out by placing an ink-jet head on a carriage and moving it reciprocally in the printing width direction of the recording medium. A maintenance unit for conducting maintenance of the ink-jet head is disposed in a location beyond the printing area of the ink-jet head. In a non-driven state, the ink-jet head is positioned facing the maintenance unit and the ink nozzle surface is capped with a cap to prevent foreign matter from adhering to the nozzle surface. Further, the thickened ink and gas bubbles admixed to the ink are removed by conducting ink discharge or ink suction through the nozzle in a capped state. After ink suction, wiping is conducted and a meniscus is prepared at the nozzle surface. Such maintenance units were the object of various improvements aimed at miniaturization (for example, Japanese Patent Application Laid-open No. 2003-94674) or creating a replaceable configuration (for example, Japanese Patent Application Laid-open No. 2000-203044).

Such maintenance units are usually attached with screws and the like to the apparatus body. When the ink-jet head is positioned facing the maintenance unit for cleaning, accurate positioning is required. Therefore, a high installation accuracy is required when the maintenance unit is attached or replaced.

### SUMMARY OF THE INVENTION

The present invention was created to resolve the above-described problems and it is an object thereof to enable accurate positioning of an ink-jet head facing a maintenance unit even if the maintenance unit has not been attached with a high installation accuracy.

In order to attain this object, the present invention provides an ink-jet recording apparatus which comprises a recording head for recording images on a recording medium by discharging ink from a nozzle, a carriage for carrying the recording head and moving it in the main scanning direction, a measurement device for measuring the position of the carriage, and a maintenance unit for conducting cleaning of the recording head, the ink-jet recording apparatus further comprising a position storage device for storing the position of the carriage, a positioning device for positioning the carriage facing the attachment position of the maintenance unit, an indication device for indicating the detection of the position of the carriage positioned with the positioning device, and a writing device for writing the carriage position detected based on the indication of the indication device in the position storage device, wherein the indication device executes the detection of the carriage position by measuring the carriage position with the measurement device or by acquiring the measurement results obtained with the measurement device.

Further, in accordance with the present invention the positioning device is composed of marks provided at the carriage and the maintenance unit, respectively, and positioning is conducted by arranging the two marks facing each other.

Further, in accordance with the present invention, the positioning device is a jig provided at the maintenance unit and positioning is conducted while bringing the carriage into contact with the jig.

With the ink-jet recording apparatus in accordance with the present invention, the carriage which has the recording head placed thereon is position facing the attachment position of the maintenance unit and this carriage position is written and stored in position storage device. Since maintenance such as cleaning of the recording head is executed in the stored position, high installation accuracy is not required during installation or replacement of the maintenance unit. Further, the carriage position is measured with measurement device, but this position may be also measured with a configuration such that the position which is constantly measured is read at the indicated timing or a configuration such that measurements are conducted at the indicated timing.

Further, positioning of the maintenance unit and carriage can be easily conducted visually by the user by employing marks provided at both the maintenance unit and the carriage.

Moreover, if a jig for positioning the maintenance unit is provided, then positioning can be carried out in an easy manner without the necessity of accurate visual positioning.

### BRIEF DESCRIPTION OF THE DRAWINGS

FIG. 1 is a front view of the ink-jet printer 1;

FIG. 2 is a block diagram illustrating the electric configuration of the ink-jet printer 1;

FIG. 3 is a flow chart illustrating the flow of a maintenance position setting process; and

FIG. 4 is a front view of the ink-jet printer 1 of another embodiment.

### DESCRIPTION OF THE PREFERRED EMBODIMENTS

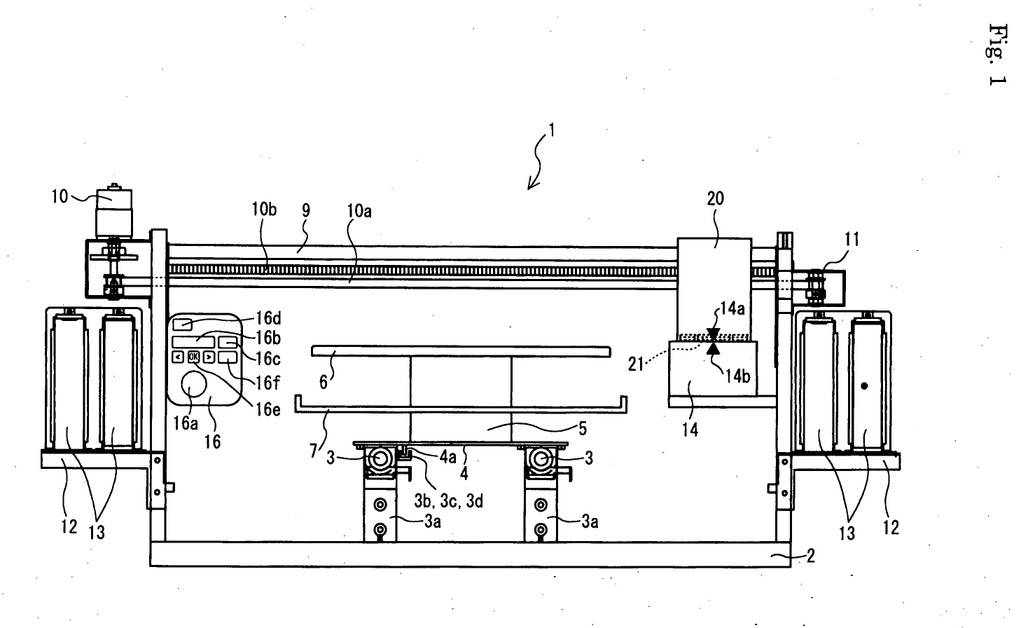

The preferred embodiments of the present invention will be described hereinbelow with reference to the appended drawings. First, the configuration of the entire ink-jet printer 1 which is an example of a printing apparatus will be described with reference to FIG. 1. FIG. 1 is a front view of the ink-jet printer 1. The direction of the paper surface in FIG. 1 is a front direction of the ink-jet printer 1.

As shown in FIG. 1, the ink-jet printer 1 comprises a casing 2 almost in the form of a rectangular parallelepiped for which the front-rear direction is a longitudinal direction. Two rails 3 oriented in the front-rear direction are arranged side by side in almost the center of the bottom surface of the casing 2. The two rails 3 are supported on respective base portions 3a rising in the vertical direction from the casing 2. A plate-like platen support base 4 which can move in the front-rear direction of the casing 2 along the rails 3 is supported on top of the rails. A replaceable platen 6 is fixed to the upper end of a support column 5 which rises vertically in almost the center of the platen support base 4.

The platen 6 is an almost rectangular plate, in a plan view thereof, with a front-rear direction of the casing 2 serving as a longitudinal direction, and is designed for carrying horizontally a recording medium composed of a cloth, for example, a T-shirt. An antisliding member (not shown in the figure) is provided at the upper surface of the platen 6 in order to prevent the T-shirt and the like from being displaced during printing, the printing surface of the T-shirt and the like being in a stretched condition. Further, edges at both sides of the platen 6 in the longitudinal direction are provided in a protruding condition, so as to obtain a trapezoidal shape.

A tray 7 which is fixed to the support column 5 in a position almost in the middle between the platen 6 and the platen support base 4 has a bottom surface almost parallel to the upper surface of the platen 6, and is constructed so that the periphery thereof, in a plan view, is larger than that of the platen 6. This tray 7 is necessary to prevent a T-shirt or the like from falling to the bottom surface of the casing 2 even when the T-shirt or the like is inadvertently dropped by the user from the platen 6 when it is placed on the platen 6.

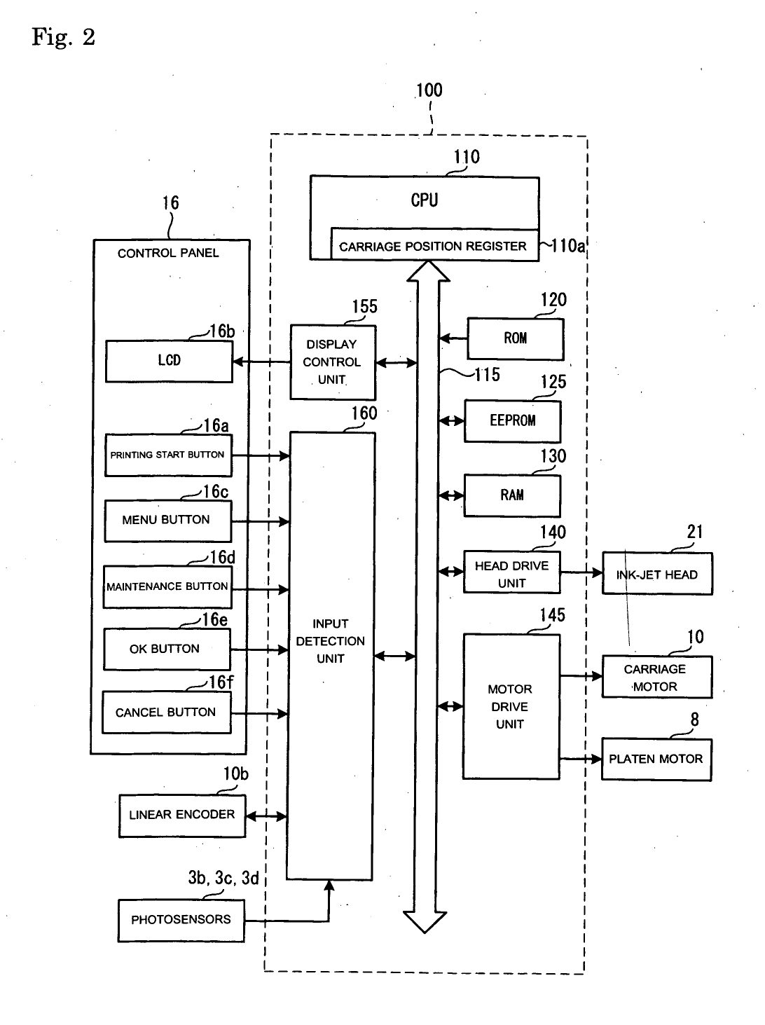

As shown in FIG. 1, a platen motor 8 (see FIG. 2) for moving the platen support base 4 in the front-rear direction of the casing 2 is provided in the vicinity of the rear end (the end portion of the rail 3 located at the back surface side of the casing 2) of the rail 3. A drive belt (not shown in the figure) is stretched between the drive shaft of the platen motor 8 and a pulley provided in the vicinity of the front end (the end portion of the rail 3 located at the front surface side of the casing 2) of the rail 3. The platen support base 4 which is fixed to this belt can move reciprocally in the front-rear direction of the casing 2 along the rails 3 when driven by the platen motor 8. A photosensor 3b for detecting that the platen 6, which moves from the back surface toward the front surface of the casing 2 during printing or reading, is in the end point in the movement direction is provided in the vicinity of the front end of the rail 3. Further, a photosensor 3c for detecting that the platen 6 is in the initial point in the movement direction during printing and a photosensor 3d for detecting that the platen 6 is in the initial point during reading are provided in the vicinity of the rear end of the rail 3. The photosensors 3b-3d comprise a light-emitting unit and a light-receiving unit (not shown in the figure), and detect the detection object based on whether the light emitted by the light-emitting portion has been received by the light-receiving unit. A shielding plate 4a, which is to detect the position of the platen 6 with the photosensors 3b-3d by interrupting between the light-emitting units and light-receiving units of the photosensors 3b-3d, is provided in a protruding condition at the lower surface of the platen support base 4. The platen motor 8 is a stepping motor, and detection of the position of the platen 6 based on the drive control of the platen motor 8 is carried out with reference to the position of the initial point or end point of the platen 6 detected by locating the shielding plate 4a between the light-emitting units and light-receiving units of those photosensors 3b-3d.

Next, as shown in FIG. 1, a guide rail 9 for guiding the movement of a carriage 20 which carries an ink-jet head 21 is installed between the two side surfaces of the casing 2 in a position above the platen 6, almost in the center of the casing 2 in the front-rear direction thereof. A carriage motor 10 which is a DC motor is provided in the vicinity of the left end of the guide rail 9, and a carriage belt 10a is installed between the guide rail 9 and a pulley 11 provided in the vicinity of the right end. The casing belt 10a is disposed from left to right of the carriage 2 in a position below the guide rail 9. The carriage belt 10a is fixed to the back surface of the carriage 20, and the carriage 20 is driven by the carriage motor 10 so as to move reciprocally in the left-right direction of the casing 2 along the guide rail 9 coupled to a coupling unit provided at the same back surface. Furthermore, a linear encoder 10b which is a measurement device for measuring the carriage position is provided below the guide rail 9. The linear encoder 10b can be of an increment type which detects a relative position with respect to the original point or of an absolute type which detects the absolute position.

The carriage 20 has a shape close to that of a rectangular parallelepiped. As shown in FIG. 1, four ink-jet heads 21 of a piezoelectric system are carried on the bottom surface thereof. The four ink-jet heads 21 are provided, for example, correspondingly to color inks of four colors: cyan, magenta, yellow, and black, and each of them is provided, for example, with 128 channels (not shown in the figure) for ejecting the respective inks. Further, each channel is provided with a piezoelectric actuator (not shown in the figure) which is driven separately and the actuators are controlled so that droplets of ink are ejected downwardly from fine ejection nozzles (not shown in the figure) formed in the bottom surface of the ink-jet head 21 correspondingly to each channel. An inversed triangular mark 14a for aligning the carriage with the below-described maintenance unit 14 is provided in the lower part at the side surface (front surface side in FIG. 1) of the carriage 20.

Cartridge accommodation portions 12 for detachably accommodating the ink cartridges 13 containing the inks are provided at the left and right side surfaces of the ink-jet printer 1. Two ink cartridges 13 can be installed in each cartridge accommodation portion 12. Each ink cartridge 13 is connected with a tube (not shown in the figure) to each ink-jet head 21 to supply inks to each channel.

A maintenance unit 14 having suction caps (not shown in the figure) that can be attached to the nozzle surface of each ink-jet head 21 and detached therefrom is provided in a position to which carriage 20 moves at the right end of the casing 2. The maintenance unit 14 is provided with a suction pump (not shown in the figure), and when each suction cap is attached to the ink-jet head 21, the ink can be sucked in via the suction caps. Further, when no printing is carried out, the nozzle surfaces of the ink-jet head 21 is covered with the suction caps and the inks are prevented from drying. A triangular mark 14b for aligning with the carriage 20 is provided in the upper part at the side surface of the maintenance unit 14 (front surface side of FIG. 1). The user can position the carriage 20 in a maintenance position facing the maintenance unit 14 by visually aligning the mark 14a of the carriage 20 and the mark 14b of the maintenance unit 14.

Further, a control panel 16 for controlling the operation of the ink-jet printer 1 is provided in a position at the left side surface at the front surface of the casing 2. In the control panel 16, there are provided a plurality of buttons such as a printing start button 16a, a menu button 16c, a maintenance button 16d, an OK button 16e, and a cancel button 16f and the like and a liquid crystal display (referred to hereinbelow as LCD) 16b for displaying the menu and various modes. If the menu button 16c is pushed, the menu is displayed, and “MAINTENANCE POSITION SETTING” is selected from the menu, then a display indicating the position is displayed at the LCD 16b. The user conducts positioning by matching the mark 14a of the carriage 20 with the mark 14b of the maintenance unit 14, and if the OK button 16e is pushed, the carriage position is stored. Such a procedure of setting a maintenance position will be described below in greater detail.

The electric configuration of the ink-jet printer 1 will be explained hereinbelow with reference to FIG. 2. FIG. 2 is a block diagram illustrating the electric configuration of the ink-jet printer 1. As shown in FIG. 2, a control unit 100 of the ink-jet printer 1 is provided with a CPU 110 for controlling the entire ink-jet printer 1. A ROM 120 storing a variety of control programs and the like executable by the CPU 110, an EEPROM 125 (position storing device) for storing the position (maintenance position) of the carriage 20 facing the maintenance unit 14, and a RAM 130 for temporarily storing data are connected to the CPU 110. Here, not only non-volatile memory, but also a volatile memory can be used as the position storing device. When a volatile memory is used, the carriage position can be held even during power source OFF if a backup circuit comprising a battery is employed. Furthermore, a head drive unit 140 for driving piezoelectric actuators provided in each channel of the ink-jet head 21, and a motor drive unit 145 for driving the carriage motor 10 and platen motor 8 are connected via a bus 115 to the CPU 110. Further, the CPU 110 is also provided with a carriage position register 110a for storing the present position of the carriage 20 measured with the linear encoder 10b.

Further, a display control unit 155 for displaying the menu or error information and like at the LCD 16b and an input detection unit 160 are connected via the bus 115 to the CPU 110. Photosensors 3b-3d, linear encoder 10b, and printing start button 16a, menu button 16c, maintenance button 16d, OK button 16e corresponding to part of indication device, cancel button 16f and other various buttons provided at the control panel 16 are connected to the input detection unit 160. The present position of the carriage 20 inputted from the linear encoder 10b is stored in the carriage position register 110a normally provided in the CPU 110 in case of an increment-type linear encoder.

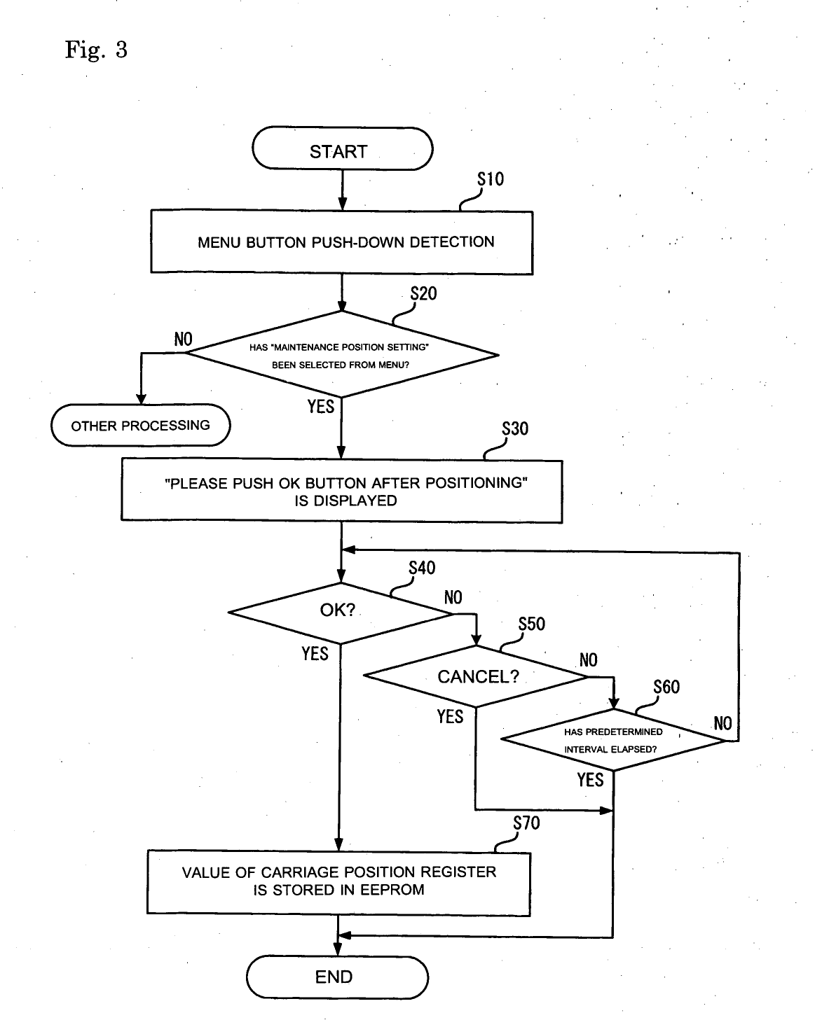

The maintenance position setting process executed in the ink-jet printer 1 will be explained hereinbelow with reference to the flow chart shown in FIG. 3. FIG. 3 is a flow chart illustrating the flow of a maintenance position setting process. The maintenance position setting process may be executed as one of initial setting, or when the maintenance unit 14 is replaced.

As shown in FIG. 3, first, a push-down of the menu button 16c of the control panel 16 is detected (S10). Then, a decision is made as to whether or not “MAINTENANCE POSITION SETTING” has been selected from the menu displayed at the LCD 16b (S20). If “MAINTENANCE POSITION SETTING” has not been selected (S20: NO), another menu processing is executed following the user's command. If “MAINTENANCE POSITION SETTING” has been selected (S20: YES), a message which instructs positioning, such as “PLEASE PUSH OK BUTTON AFTER POSITIONING”, is displayed at the LCD 16b (S30).

Then, a decision is made as to whether the OK button 16e has been pushed (S40). If the OK button 16e has not been pushed (S40: NO), a decision is made as to whether or not the cancel button 16f has been pushed (S50), and if the cancel button 16f has been pushed (S50: YES), the processing is completed. If the cancel button 16f has not been pushed (S50: NO), a decision is made as to whether or not the predetermined interval (for example, 60 sec) has elapsed since the message which instructs positioning was displayed at the LCD 16b in S30 (S60). If the predetermined interval has elapsed (S60: YES), the processing is completed. If the predetermined interval has not yet elapsed (S60: NO), the processing flow returns to S40 and a decision is made as to whether the OK button 16e has been pushed.

If the OK button 16e has been pushed (S40: YES), the user conducts positioning of the carriage 20 and maintenance unit 14 and it is decided that the carriage 20 has been moved to the adequate position, thereby the value stored in the carriage position register 110a, that is, the present position of the carriage 20, is stored in the EEPROM 125 as a maintenance position of the carriage 20 (S70). Here, the relative position from the linear encoder 10b to the original point is normally stored in the carriage position register 110a. Further, when an absolute-type encoder is used as the linear encoder 10b, an instruction to measure the present position of the carriage 20 may be issued to the linear encoder 10b and the measurement results thus obtained may be stored in the EEPROM 125.

The operation of the ink-jet printer 1 having the above-described configuration will be schematically described hereinbelow. If a power source of the ink-jet printer 1 is turned on, the control program stored in the ROM 120 is read and initial setting processes of various kinds are carried out. If printing data is transmitted from an external device, it is stored in the RAM 130. The user places a T-shirt or the like, which is the recording medium, on the platen 6, verifies by the LCD 16b or the like that the conditions relating to printing possibility are satisfied, and pushes down the printing start button 16a. As a result, the printing operation is executed. Thus, the platen motor 8 is driven once and the platen 6 is moved to the starting point (position detected with the photosensor 3c) of printing at the back surface side of the casing 2. Then, the platen 6 is moved at a constant speed toward the end point (position detected with the photosensor 3b), the carriage 20 is reciprocally moved in the direction perpendicular to the movement direction of the platen 6, following the movement of the platen 6, and the ejection of ink droplets from the ink-jet head 21 is carried out according to the printing data. When the user pushes the maintenance button 16d and maintenance such as purging is executed, the maintenance position stored in the EEPROM 125 is read out, the carriage 20 moves to this position, and maintenance is executed.

As described hereinabove, with the ink-jet printer 1 of the present embodiment, if the user selects the setting of maintenance position from the menu, aligns the positions of the carriage 20 and maintenance unit 14 by matching the mark 14a and mark 14b, and pushes the OK button 16e, this position of the aligned carriage 20 is detected and stored as the maintenance position in the EEPROM 125. If the user then pushes the maintenance button 16d to execute the maintenance, the maintenance position stored in the EEPROM 125 is read out, the carriage 20 is moved to this position, and maintenance is executed. Therefore, if the process of setting the maintenance position is executed as an initial setting prior to the initial operation of the ink-jet printer 1 or the process of setting the maintenance position is executed immediately after the maintenance unit 14 has been replaced, then maintenance such as purging or the like can be executed in an adequate position, regardless of the installation accuracy of the maintenance unit 14.

The CPU 110 which causes the EEPROM 125 to store the value of the carriage position register in S70 of the flow chart shown in FIG. 3 functions as writing device in accordance with the present invention.

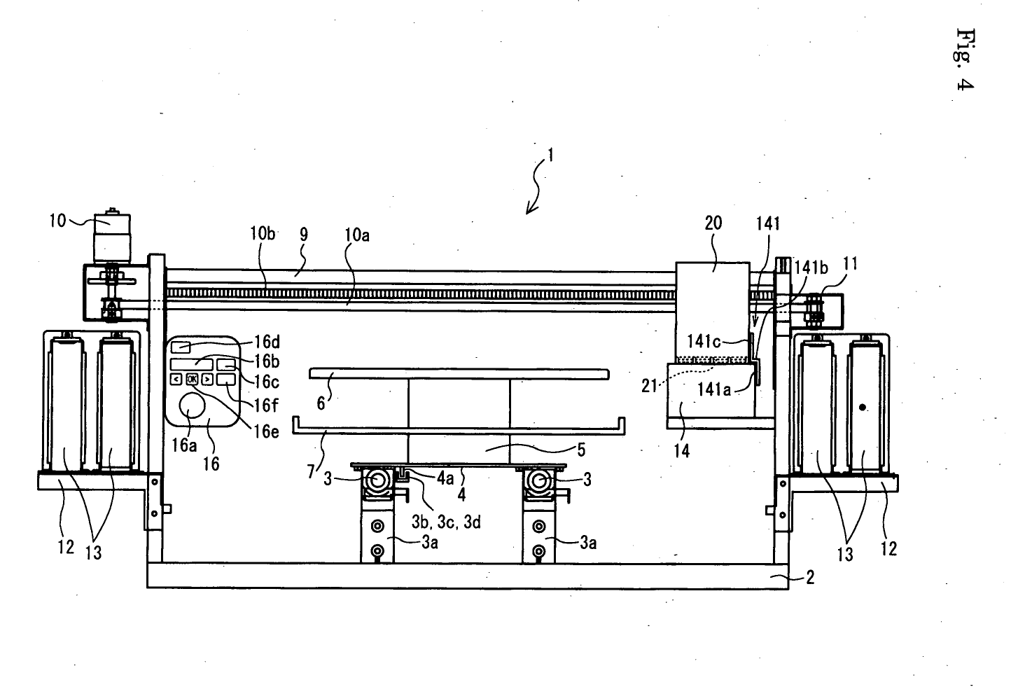

The preferred embodiment relating to a case where a jig is used as the positioning device will be described hereinbelow with reference to FIG. 4. FIG. 4 is a front view of the ink-jet printer 1 of another embodiment. Because the entire configuration of the ink-jet printer 1 shown in FIG. 4, except the jig 141 which is positioning device, is identical to that shown in FIG. 1, the identical reference numerals are used and the explanation thereof is omitted.

As shown in FIG. 4, a jig 141 formed from a metal sheet such as a stainless steel sheet or an aluminum sheet is provided at the side surface of the maintenance unit 14. The jig 141, as shown in FIG. 4, has a shape obtained by placing an L-like pattern on an inverted L-like pattern, in a front surface view thereof, and is composed of a foot portion 141a which is abutted against and bonded to the side surface of the maintenance unit 14, a horizontal portion 141b which is abutted against and bonded to the upper surface of the maintenance unit 14 and is formed at a right angle to the foot portion 141a, and a positioning portion 141c formed so as to extend vertically upward from the horizontal portion 141b. Further, the configuration is such that the carriage 20 is brought into contact with the positioning portion 141c. The jig 141 is formed by adjusting the length of the horizontal portion 141b according to the size of the maintenance unit 14 and carriage 20 so that the carriage 20 can assume a maintenance position enabling capping in the ink-jet head 21.

When the process of setting the maintenance position is executed in the embodiment according to the flow chart shown in FIG. 3, the user selects “MAINTENANCE POSITION SETTING” from the menu and carries out positioning by moving the carriage 20 till it abuts against the positioning portion 141c of the jig 141. If the OK button 16e is then pushed, the present position of the carriage 20 is stored in the EEPROM 125 (FIG. 3, S70).

As described hereinabove, with the ink-jet printer 1 of the present embodiment, if the user selects the setting of maintenance position from the menu, aligns the positions of the carriage 20 and maintenance unit 14 by causing the carriage 20 to abut against the positioning portion 141c of the jig 141, and pushes the OK button 16e, this position of the aligned carriage 20 is detected and stored as the maintenance position in the EEPROM 125. If the user then pushes the maintenance button 16d to execute the maintenance such as purging, the maintenance position stored in the EEPROM 125 is read out, the carriage 20 is moved to this position, and maintenance such as purging is executed. Therefore, if the process of setting the maintenance position is executed as an initial setting prior to the initial operation of the ink-jet printer 1 or the process of setting the maintenance position is executed immediately after the maintenance unit 14 has been replaced, then maintenance such as purging or the like can be executed in an adequate position, regardless of the installation accuracy of the maintenance unit 14.

The present invention is generally suitable for inkjet recording apparatuses in which maintenance of a printing head is carried out using a maintenance unit.

The entire disclosure of the specification, claims, summary and drawings of Japanese Patent Application No. 2003-337002 filed on Sep. 29, 2003 is hereby incorporated by reference.

1. An ink-jet recording apparatus comprising:
a recording head for recording images on a recording medium by discharging ink from a nozzle;
a carriage for carrying said recording head and moving it in the main scanning direction;
a measurement device for measuring the position of said carriage; and
a maintenance unit for conducting cleaning of said recording head, the ink-jet recording apparatus further comprising:
a position storage device for storing the position of said carriage;
a positioning device for positioning said carriage facing the attachment position of said maintenance unit;
an indication device for indicating the detection of the position of said carriage that was positioned with said positioning device; and
a writing device for writing said carriage position detected based on the indication of said indication device in said position storage device, wherein
said indication device executes the detection of said carriage position by measuring said carriage position with said measurement device or by acquiring the measurement results obtained with said measurement device.

2. The ink-jet recording apparatus according to claim 1, wherein
said positioning device is composed of marks provided at said carriage and said maintenance unit, respectively, and positioning is conducted by arranging the two marks facing each other.

3. The ink-jet recording apparatus according to claim 1, wherein
said positioning device is a jig provided at said maintenance unit and positioning is conducted while bringing said carriage into contact with said jig.
